(19) United States
(12) Patent Application Publication
(10) Pub. No.: US 2005/0032916 A1
(43) Pub. Date: Feb. 10, 2005

(54) Perfume oil emulsions

(76) Inventor: George Endel Deckner, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/912,826

(22) Filed: Aug. 6, 2004

Related U.S. Application Data
(60) Provisional application No. 60/493,280, filed on Aug. 7, 2003.

(51) Int. Cl. B01F 17/00

(52) U.S. Cl. 516/53

(57) ABSTRACT

In a first aspect, the invention concerns oil-in-water emulsions comprising defined water-soluble emulsification polymers and having an oil phase comprising polar oils. In a second aspect, products, such as cosmetic products, are provided, comprising the emulsions. In a third aspect, a manufacturing method is provided for making the products.

### CROSS REFERENCE TO RELATED APPLICATION

This application claims the benefit of U.S. Application No. 60/493,280, filed 07 Aug. 2003.

### FIELD OF THE INVENTION

The present application concerns oil-in-water emulsions having a polar oil phase emulsified by non-alkoxylated water-soluble emulsification polymers. In a second aspect, products, such as cosmetic products, are provided, comprising the emulsions. In a third aspect, a manufacturing method is provided for making the products.

### BACKGROUND OF THE INVENTION

Emulsions are generally stabilised by appropriate emulsifying surfactants, which, by virtue of their amphiphillic structure, reside at the oil/water interface and thus stabilise the dispersed droplets. These surfactants typically exhibit the disadvantage, however, of penetrating and potentially irritating the skin, eyes and scalp and generally giving a poor skin feel. Furthermore, the use of conventional surfactants to manufacture emulsions typically necessitates the application of heat during processing, which can also be disadvantageous, in that it can restrict the ability to include heat-sensitive ingredients and in that it may also limit the types of place in which the manufacturing method may be performed—safety and other concerns, may, for example, prohibit manufacturing the emulsions in certain desired locations.

Another disadvantage of traditional surfactants, including alkoxylated surfactants, is that they may cause materials to re-emulsify after the emulsion breaks—emulsion breakage allows delivery of emulsified materials, but re-emulsification, such as after application of a personal cleansing composition to the skin during washing/showering, may reduce the desired benefit (because emulsified emollients and actives are washed off the skin in this example).

A further disadvantage of conventional surfactants is their inability satisfactorily to emulsify polar oils—many perfume oils fall within this category.

U.S. Pat. No. 6,403,109 teaches oil-in-water emulsions comprising perfume oils. The exemplified emulsifiers are ethoxylated materials however, which suffer from the problems discussed hereinabove.

Concentrated emulsions having a high discontinuous phase, wherein the discontinuous phase comprises water or oil, for example, are known and have found application in a number of technologies, such as fuels, cosmetics and foods—an everyday example of these emulsions is mayonnaise (which may typically comprise about 70% vegetable oil in water). These concentrated emulsions have also found application in the cosmetic area because the concentrates can stably contain high concentrations of, for example, emollients, moisturisers and sunscreens, which can then be diluted down using simple cold mixing to obtain the desired end product. Reference may be made to U.S. Pat. No. 4,606,913 and U.S. Pat. No. 5,976,604, which teach concentrated emulsions.

In the light of the above considerations, it would be beneficial to develop oil-in-water emulsions which have a reduced capacity to irritate human skin and membranes. In addition, it would be advantageous to develop emulsions which are more substantive to the substrate to which they are applied, such as human skin or fabrics, and exhibit a reduced tendency to re-emulsify once broken. Furthermore, it would be beneficial to develop emulsions in which polar oils can be satisfactorily emulsified.

### SUMMARY OF THE INVENTION

According to a first aspect of the invention, an emulsion is provided, the emulsion comprising a discontinuous oil phase, an aqueous continuous phase and emulsifier, wherein the emulsifier comprises one or more non-alkoxylated water-soluble emulsification polymers, wherein the or each non-alkoxylated water-soluble emulsification polymer has a weight average molecular weight of at least 3000 Daltons, and wherein the oil phase has a dielectric constant from 6.5 to 14 measured at 20° C.

As used herein, the term “emulsification polymer” includes polymers that have surface-active properties.

As used herein, the term “non-alkoxylated” in relation to the water-soluble emulsification polymers means polymers comprising no alkoxy groups, that is no —OR groups (where R includes alkyl moieties) in the molecule, neither in the polymer backbone, nor as pendants thereto, nor elsewhere.

As used herein, the word “oil” includes water immiscible materials that are liquid at ambient conditions, materials that are solid at ambient conditions, have a melting temperature of less than 100° C. and melt to form a water immiscible liquid and mixtures of such materials.

As used herein, the term “oil-in-water” or “o/w” means that an oil phase is dispersed in an aqueous phase, such that the aqueous phase is the continuous phase and the oil phase the discontinuous phase; as used herein, the term “water-in oil” or “w/o” means that water is dispersed in the oil phase.

According to a second aspect of the invention, personal care, health care and laundry products are provided comprising the emulsion defined in the first aspect of the invention.

According to a third aspect of the invention, a manufacturing method is provided for making the defined products.

### DETAILED DESCRIPTION OF THE INVENTION

All weights, measurements and concentrations herein are measured at 25° C. on the composition in its entirety, unless otherwise specified.

Unless otherwise indicated, all percentages of compositions referred to herein are weight percentages of the total composition (i.e. the sum of all components present) and all ratios are weight ratios.

Unless otherwise indicated, polymer molecular weights are weight average molecular weights.

Unless otherwise indicated, the content of all literature sources referred to within this text are incorporated herein in full by reference.

Except where specific examples of actual measured values are presented, numerical values referred to herein should be considered to be qualified by the word “about”.

The emulsifier according to the invention comprises a non-alkoxylated water-soluble emulsification polymer. The present polymers may emulsify polar oils and the resulting emulsions may be more substantive than non-polymeric emulsifiers. The water-soluble emulsification polymers according to the invention have a molecular weight of at least 3000 Daltons, since below this level, the resulting emulsions have poor skin feel. Skin feel improves with increasing molecular weight and it is preferred that the water-soluble emulsification polymers according to the invention have a molecular weight above 7500 Daltons, more preferably above 9000 Daltons and, more preferably still, above 10,000 Daltons.

The molecular weight of the emulsification polymers advantageously does not exceed 130 kiloDaltons; above this point, especially at the concentrations of emulsification polymer that one would typically use and when the internal oil phase is present at levels above 80% by weight of the emulsion, the viscosity of the aqueous phase may reach a level that hinders emulsification.

Advantageously, the non-alkoxylated water soluble emulsification polymers according to the invention include those a 0.% wt aqueous solution of which have a surface tension of 15-60 mN/m (15-60 dynes/cm) when measured at 25° C. Within this surface tension range, beneficial emulsification properties are observed.

Advantageously, at least 50% wt, preferably at least 75% wt and more preferably at least 90% wt of the total weight of emulsifier comprised within the present emulsions consists of one or more non-alkoxylated water-soluble emulsification polymers. Highly advantageously, the emulsifier comprised within the present emulsions consists only of one or more non-alkoxylated water-soluble emulsification polymers according to the invention.

Surprisingly, it has been found that non-alkoxylated, water-soluble polymers according to the invention are capable of emulsifying a polar oil phase and mitigating the problems encountered in the prior art. This applies regardless of the chemical nature of the water-soluble polymer, so that polymers of widely differing chemistries may be employed. Non-limiting water-soluble polymers which may be employed according to the invention include: alkylated polyvinylpyrrolidone, such as butylated polyvinylpyrrolidone commercialised as “Ganex P904” by ISP Corp.; mono alkyl esters of poly(methyl vinyl ether/maleic acid) sodium salt, including mono butyl ester of poly(methyl vinyl maleic acid sodium salt) such as included in the product commercialised as “EZ Sperse” by ISP Corp; isobutylene/ethylmaleimide/hydroxyethyl copolymer, such as included in the product commercialised as “Aquafix FX64” by ISP Corp.; (3-dimethylaminopropyl)-methacrylamide/3-methacryloylamidopropyl-lauryl-dimthyl-ammonium chloride, such as included in the product commercialised as Styleze W20 by ISP Corp.

Advantageously, the non-alkoxylated, water-soluble polymers according to the invention have film-forming properties. This property is found in higher molecular weight polymers, especially those having a weight average molecular weight above 10,000 Daltons. The film-forming property may further increase skin feel and substantivity of the emulsions on the substrate versus traditional surfactants, including alkoxylated surfactants. Dried-down oil-in-water emulsions comprising traditional surfactants, including alkoxylated surfactants, suffer from the disadvantage that they may re-emulsify when wetted, whereas the present non-alkoxylated, water-soluble polymers are less liable to do that. The substantivity is further increased when the polymers exhibit film-forming properties, since the films may act to retain the oil phase in situ.

The emulsions according to the invention may comprise from 0.1% to 15%, preferably from 0.1% to 5% and more preferably 0.1 to 2.5% by weight water-soluble emulsification polymer.

The polar oil phase according to the present invention has a dielectric constant in the range 6.5 to 14, when measured at 20° C. Preferably, the dielectric constant is from 10 to 14, more preferably from 12 to 14. The higher the dielectric constant, the more polar the oil phase.

Examples of oils having a dielectric constant in this range are provided in Table 1.

TABLE 1

| Perfume Oil | Dielectric Constant |
|---|---|
| Citral | 13.80 |
| Beta Gamma Hexenol | 13.70 |
| Benzyl Alcohol | 13.00 |
| Phenyl Ethyl Alcohol | 12.16 |
| Ionone Gamma Methyl | 10.03 |
| Ethyl 2-Methyl Butyrate | 9.48 |
| Ethyl Methyl Phenyl Glycidate | 9.48 |
| Helional | 8.49 |
| Melonal | 8.22 |
| Citronellol | 7.61 |
| Floralozone | 7.10 |
| Syringa Aldehyde | 7.05 |
| Cis Hexenyl Salicylate | 6.94 |
| Decyl Aldehyde | 6.93 |

The oil phase may comprise one or more oils, provided that the dielectric constant of the oil phase is in the defined range.

Materials comprised within the oil phase may include aliphatic or aromatic hydrocarbons, esters, alcohols, ethers, carbonates, fluorocarbons, silicones, fluorosilicones or derivatives thereof provided that the oil phase has a dielectric constant in the defined range.

Advantageously, materials comprised within the oil phase have a viscosity in the range from 0.005 to 30,000 cm²/s (0.5 to 3,000,000 cst), preferably from 0.005 to 20,000 cm²/s (0.5 to 2,000,000 cst), more preferably from 0.005 to 3500 cm²/s (0.5 to 350,000 cst).

The emulsion may comprise an oil phase varying from a few percent by weight up to over ninety percent by weight of the emulsion. Typically, the emulsions would contain less than 50% wt oil phase, but in one non-limiting embodiment, the present invention relates to emulsions having a concentrated internal or discontinuous oil phase, which represents at least 50% by weight of the emulsion, preferably at least 70%, more preferably at least 80% and more preferably still from 80 to 93% by weight of the emulsion.

The aqueous phase of the emulsions according to the invention comprises water and may also comprise additional water-soluble components, such as alcohols; humectants, including polyhydric alcohols (e.g. glycerine and propylene glycol); active agents such as d-panthenol, vitamin B₃ and its derivatives (such as niacinamide) and botanical extracts; thickeners and preservatives.

Preferably, the viscosity of the aqueous phase does not exceed 2 kg/ms (2000 cps), measured using a Brookfield Digital Rheometer Model DV-III, with an RV2 spindle at 20 rpm (Brookfield Engineering Laboratories—Stoughton Mass.) at 20° C. Above this point, emulsification may become extremely difficult, especially when the internal oil phase is present at high levels, such as 80-90% by weight of the emulsion.

The emulsions according to the invention may be further processed to generate final compositions, which may be personal care compositions, health care compositions, laundry or other compositions. These final compositions may comprise additional components, the precise nature of which will depend on the nature of the final composition—for example, whether it is a perfume gel, a vapour rub cream or a laundry composition—so that it is not possible to present an exhaustive list here. Non-limiting examples of other components include solvents, including water; thickeners; humectants, such as polyhydric alcohols, including glycerine and propylene glycol; pigments, including organic and inorganic pigments; preservatives; chelating agents, antimicrobials, perfumes. Surfactants, such as non-ionic, anionic, cationic, zwitterionic and amphoteric surfactants, may also be present, although, as stated above, it is preferred that the majority, or indeed, all of emulsifier present consist of the defined non-alkoxylated water-soluble emulsification polymers.

According to a second aspect of the invention, a method of manufacture of the emulsions according to the invention is provided. The method comprises the following steps:
(a) Manufacturing a concentrated emulsion comprising at least 50% by weight of the emulsion of discontinuous oil phase, an aqueous continuous phase and emulsifier, wherein the emulsifier comprises one or more non-alkoxylated, water-soluble emulsification polymers, wherein the or each non-alkoxylated, water-soluble emulsification polymer has a weight average molecular weight of at least 3000 Daltons, and wherein the oil phase has a dielectric constant from 6.5 to 14 measured at 20° C.

The concentrated emulsion generated in step (a) may be a product in its own right. Alternatively, step (b1) may be carried out:
(b1) Diluting the concentrated emulsion generated in step (a), by adding additional aqueous phase to the emulsion with continuous mixing until a uniform consistency is obtained. Mixing may be at ambient conditions.

In a further alternative, if a final composition is desired comprising other components, such as cosmetic components, then Step (b2)-(d) may be carried out:
(b2) Manufacturing a pre-mix of all other components of the final composition;
(c) Adding the concentrated emulsion to the pre-mix with continual mixing.
(d) Continuing mixing until composition of uniform consistency is obtained.

Advantageously, the method comprises the additional step (e) of continuing mixing until a desired oil phase particle size is obtained. Beneficially, the oil phase particle size is in the range from 1 to 20 μm.

The final composition comprises from 0.01 to 30% wt, preferably from 0.25 to 15% wt of the concentrated emulsion prepared according to step (a).

Step (a), above, defines the manufacture of a concentrated emulsion. A typical concentrated emulsion may contain 1-5% water-soluble emulsification polymer and 6-15% aqueous phase, although these ranges are not limiting. Typically, the aqueous phase comprises 100% water or a mixture of water and other water-soluble components.

There follow more details relating to performance of step (a): firstly, the water-soluble emulsification polymer is added to the aqueous phase with mixing. Following this, discrete batches of 2-3% of the total weight of oil are titrated sequentially into the aqueous phase accompanied by gentle mixing to obtain a uniform consistency prior to addition of the following batch. This is continued until around 20% of the total weight of oil has been added. In a second step, the remainder of the oil is now added more rapidly and in a continuous fashion with more vigorous mixing until a uniform emulsion comprising all the oil is obtained. In a third step, mixing is continued until a uniform consistency is obtained exhibiting a typical particle in a desired range. The concentrated emulsion obtained typically comprises above 70%, and more often from 80 to 93% internal oil phase by weight of the emulsion and forms a stable concentrate that may be stored or transported to other locations.

Step (b2) of the manufacturing method involves the creation of a pre-mix of all other components of the final composition. The precise nature of these other components will depend on the nature of the final product, so that it is not possible to present an exhaustive list here. Non-limiting examples of other components include solvents, including water; thickeners; humectants, such as polyhydric alcohols, including glycerine and propylene glycol; pigments, including organic and inorganic pigments; preservatives; chelating agents, antimicrobials, perfumes. Surfactants, such as non-ionic, anionic, cationic, zwitterionic and amphoteric surfactants, may also be present, although, in one preferred embodiment, the majority, or indeed, all of the emulsifier present consists of the defined non-alkoxylated water-soluble emulsification polymers.

Steps (c)-(e) of the manufacturing method involve addition of the concentrated emulsion of step (a) to the pre-mix of step (b2), mixing to achieve a uniform consistency and, preferably, further mixing to achieve a desired particle size. The mixing steps do not require any special conditions and may be carried out at room temperature and low shear mixing. The possibility of “cold mixing”, i.e. mixing at ambient conditions without the application of heat, is a major advantage of the present method, since it permits great flexibility in the location in which process steps (b2)-(e) may be carried out. In particular, cold mixing gives rise to fewer safety concerns.

Measurement Methods

Testing the Solubility of the Water-Soluble Emulsification Polymers

As used herein in relation to the emulsification polymers, the term “water-soluble” includes polymers fulfilling the following condition: a 1% wt solution of the polymer in de-ionised water at room temperature gives at least 90% transmittance of light having a wavelength in the range from 455 to 800 nm. Testing was carried out by passing the polymer solution through a standard syringe filter into a 1 cm path length cuvette having a pore size of 450 nm and scanning using an HP 8453 Spectrophotometer arranged to scan and record across 390 to 800 nm. Filtration was carried out to remove insoluble components.

Measurement of Surface Tension

The method used for measuring surface tension of fluid is the so-called “Wilhelmy Plate Method”. The Wilhelmy plate method is a universal method especially suited to establishing surface tension over time intervals. In essence, a vertical plate of known perimeter is attached to a balance, and the force due to wetting is measured. More specifically:

A 0.1% wt aqueous solution of water-soluble emulsification polymer is made up in de-ionised water. The polymer solution is then poured into a clean and dry glass vessel, the solution temperature being controlled at 25° C. The clean and annealed Wilhelmy Plate is lowered to the surface of the liquid. Once the plate has reached the surface the force which is needed to remove the plate out of the liquid is measured.

The equipment used and corresponding settings are as follows:

Device: Krüss Tensiometer K12, manufactured by Krüss GmbH, Borsteler Chausee 85-99a, 22453 Hamburg-Germany (see www.kruess.com).

Plate Dimensions: Width: 19.9 mm; Thickness: 0.2 mm; Height: 10 mm

Measurement Settings: immersion depth 2 mm, Surface Detection Sensitivity 0.01 g, Surface Detection Speed 6 mm/min, Values 10, Acquisition linear, Maximum Measurement Time 60 sec

The plate is immersed in the fluid and the corresponding value of surface tension is read on the display of the device. Instructions can be found in the user manual edited by “Krüss GmbH Hamburg 1996” Version 2.1.

Testing the Dielectric Constant of the Polar Oils

Measurements were taken at 20° C. using a Model 870 liquid dielectric constant meter manufactured by Scientifica in Princeton N.J. Readings were taken once equilibrium had been reached (in the rule, it took five to achieve a constant value).

### EXAMPLES

The following examples further describe and demonstrate the preferred embodiments within the scope of the present invention. The examples are given solely for the purpose of illustration, and are not to be construed as limitations of the present invention since many variations thereof are possible without departing from its scope.

### Example 1

### Perfume Gel

Concentrated Oil-In-Water Emulsion

| Material | % wt | Weight (g) |
|---|---|---|
| EZ Sperse | 2.5 | 25 |
| Water | 17.5 | 175 |
| “Electric Youth Plus” | 80.0 | 800 |
| Fragrance Oil | | |

Electric Youth Plus fragrance (a combination of perfume oils) has a dielectric constant of 7.40.

Procedure to Make the Concentrated Oil-In-Water Emulsion

The EZ Sperse and 7.5% wt water were mixed using a Kitchen Aid Ultra Power Mixer until uniform. The fragrance oil was then added at a rate of 8 g/minute while continually mixing with a Kitchen Aid Ultra Power Mixer having a paddle attachment at a setting of “4”. Due to the high viscosity, the emulsion was then diluted with the remainder of the water while continually mixing with a Kitchen Aid Ultra Power Mixer having a paddle attachment at a setting of “4”.

Perfume Gel

| Material | % wt |
|---|---|
| Deionised water | 86.5 |
| Seppigel 305 | 3.5 |
| Concentrated perfume o/w emulsion | 10.0 |

Procedure to Make Perfume Gel

All mixing was carried out using a Kitchen Aid Ultra Power Mixer with a paddle attachment and a speed setting of “2”.

The Seppigel 305 was dispersed in the water and mixed until a smooth gel was obtained, at which point the perfume o/w emulsion was added and mixed until a uniform consistency perfume gel was produced.

### Example 2

### Baby Vapour Rub Cream

Essential Oil Mix

| Material | % wt |
|---|---|
| Eucalyptus oil | 76.79 |
| Rosemary oil | 13.39 |
| Aloe vera oil extract | 8.93 |
| Lavender Oil | 0.89 |

The essential oil mix has a dielectric constant of 13.39.

The essential oils were mixed uniformly, then incorporated into an oil-in-water emulsion having the following composition:

Essential Oil Concentrated Oil-In-Water Emulsion

| Material | % wt |
|---|---|
| EZSperse | 10 |
| Water | 10 |
| Essential Oil Mix | 80 |

Water and EZ Sperse were mixed using a Kitchen Aid Ultra Power Mixer until uniform. The essential oils were then added to the water/EZ Sperse while continually mixing with a Kitchen Aid Ultra Power Mixer having a paddle attachment at a setting of “4” until a uniform oil-in-water emulsion was obtained.

Baby Vapour Rub Cream

| Material | % wt |
|---|---|
| Deionised water | 69.80 |
| Glycerine | 5.00 |
| 1,2-hexanediol | 2.00 |
| Ethyl paraben | 0.14 |
| Benzyl alcohol | 0.25 |
| Luvigel EM (BASF)¹ | 4.90 |
| Brij 30² | 0.10 |
| AM 900 | 4.50 |
| Essential oil concentrated oil-in-water | 13.30 |
| emulsion | |

¹Caprylic/Capric Triglyceride (and) Sodium Acrylates Copolymer from BASF
²Laureth-4 from Uniquema

All mixing was carried out using a Kitchen Aid Ultra Power Mixer.

The following premixes were prepared:
A. Glycerine and water
B. 1,2-hexanediol, ethyl paraben and benzyl alcohol
C. Luvigel EM and Brij 30

Following preparation of the premixes, premix A was added to premix B with mixing until uniform. After this, premix C was added and mixed until a smooth creamy consistency had been achieved, at which point the AM 900 was incorporated, again with mixing. Finally, the concentrated oil-in-water emulsion was added and the whole was mixed to achieve a uniform consistency baby vapour rub cream.

It is understood that the examples and embodiments described herein are for illustrative purposes only and that various modifications or changes in light thereof will be suggested to one skilled in the art without departing from the scope of the present invention.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An emulsion comprising:
(a) a discontinuous oil phase;
(b) an aqueous continuous phase; and
(c) emulsifier;
wherein the emulsifier comprises one or more non-alkoxylated water-soluble emulsification polymers; wherein the non-alkoxylated water-soluble emulsification polymer has a weight average molecular weight of at least about 3000 Daltons; wherein the oil phase has a dielectric constant from about 6.5 to about 14 measured at about 20° C.

2. The emulsion of claim 1, wherein at least about 75% of the total weight of emulsifier consists of one or more non-alkoxylated water-soluble emulsification polymers.

3. The emulsion of claim 2, wherein the emulsifier consists of one or more non-alkoxylated water-soluble emulsification polymers.

4. The emulsion of claim 1, wherein a 0.1% wt aqueous solution of the non-alkoxylated water soluble emulsification polymer has a surface tension of about 15 to about 60 mN/m (about 15 to about 60 dynes/cm) when measured at about 25° C.

5. The emulsion of claim 1, wherein the water-soluble emulsification polymer has a molecular weight of more than about 10,000 Daltons.

6. The emulsion of claim 1, wherein the emulsification polymer has a molecular weight of less than about 130 kiloDaltons.

7. The emulsion of claim 1, wherein at least one of the water-soluble emulsification polymers is a film-forming polymer.

8. The emulsion according to claim 1, wherein the emulsifier comprises one or more of the water-soluble emulsification polymers selected from the group consisting of mono alkyl esters of poly(methyl vinyl ether/maleic acid) sodium salt; alkylated polyvinylpyrrolidone; terephthalate polyesters and (3-dimethylaminopropyl)-methacrylamide/3-methacryloylamidopropyl-lauryl-dimthyl-ammonium chloride and mixtures thereof.

9. The emulsion of claim 1, wherein the oil phase has a dielectric constant from about 10 to about 14.

10. The emulsion of claim 1, wherein the oil phase has a dielectric constant from about 12 to about 14.

11. The emulsion of claim 1, wherein the oil comprised within the oil phase has a viscosity in the range from about 0.005 cm²/s to about 30,000 cm²/s.

12. The emulsion according to claim 1, comprising greater than about 70% wt of the oil phase.

13. The emulsion of claim 1, comprising from about 80 to about 93% wt of the oil phase.

14. A product comprising an emulsion according to claim 1, wherein the product is selected from the group consisting of personal care, health care and laundry products.

15. The product of claim 14, wherein the personal care product is selected from the group consisting of a lotion, a shampoo, a make-up and a perfume gel.

16. The product of claim 15, wherein the lotion is a hand and body lotion.

17. The product of claim 14, wherein the health care product is a vapour rub cream.

18. An emulsion comprising:
(a) a discontinuous oil phase;
(b) an aqueous continuous phase; and
(c) emulsifier;
wherein the emulsifier consists of one or more non-alkoxylated water-soluble emulsification polymers; wherein the non-alkoxylated water-soluble emulsification polymer has a weight average molecular weight of at least about 10,000 Daltons; wherein the oil phase has a dielectric constant from about 6.5 to about 14 measured at about 20° C.

19. An emulsion comprising:
(a) a discontinuous oil phase;
(b) an aqueous continuous phase; and
(c) emulsifier
wherein the emulsifier comprises one or more non-alkoxylated water-soluble emulsification polymers; wherein the non-alkoxylated water-soluble emulsification polymer has a weight average molecular weight of at least about 10,000 Daltons; wherein the oil phase has a dielectric constant from about 6.5 to about 14 measured at about 20° C.; wherein at least one of the one or more water-soluble emulsification polymers is a film-forming polymer.

20. The emulsion of claim 19, wherein all of the water-soluble emulsification polymers are film-forming polymers.

21. Method of manufacture of a personal care, health care or laundry product comprising the steps of:
(a) Manufacturing a concentrated emulsion comprising:
i. at least about 50% by weight of the emulsion of discontinuous oil phase;
ii. an aqueous continuous phase; and
iii. emulsifier, wherein the emulsifier comprises one or more non-alkoxylated, water-soluble emulsification polymers; wherein the non-alkoxylated, water-soluble emulsification polymer has a weight average molecular weight of at least about 3000 Daltons; wherein the oil phase has a dielectric constant from about 6.5 to about 14 measured at about 20° C.;
(b) manufacturing a pre-mix of all other components of the personal care, health care or laundry product;
(c) adding the concentrated emulsion to the pre-mix with continual mixing.
(d) mixing until a personal care, health care or laundry product of uniform consistency is obtained.

22. The method of claim 21, comprising the additional step of continuing mixing until a desired oil phase particle size is obtained.

23. The method of claim 22, wherein the oil phase particle size is in the range from about 1 to about 20 μm.

24. The method of claim 21, wherein the concentrated emulsions comprises from about 0.01 to about 30% wt of the personal care composition.

25. The method of claim 21, wherein the concentrated emulsions comprises from about 0.25 to 15% wt of the personal care composition.
